(19) United States
(12) Patent Application Publication
(10) Pub. No.: US 2006/0178895 A1
(43) Pub. Date: Aug. 10, 2006

(54) Business method selling a good

(76) Inventors: Nabi Djellal, Marseille (FR); Haiat Menkoucha, Marseille (FR)

Correspondence Address: BROWDY AND NEIMARK, P.L.L.C.;624 NINTH STREET, NW, SUITE 300, WASHINGTON, DC, 20001-5303, US

(21) Appl. No.: 11/053,418

(22) Filed: Feb. 9, 2005

(51) Int. Cl. G06Q 99/00

(52) U.S. Cl. 705/1

(57) ABSTRACT

A computerized method for awarding a product, service, or activity package by the steps of: receiving from a participant a request for a chance to obtain the product, service or package; storing a record of the request and identification of the participant in a database; transmitting to the participant instructions for remitting payment for the chance; receiving confirmation of payment and storing a record of the confirmation in the database; assigning an index value to the share; transmitting the assigned index value to the participant and storing the assigned index value in the database; repeating the above steps for subsequent participants; determining a value from an external index at a given time; comparing the index value assigned to each participant with the determined external index value; and awarding the product, service, or activity package to that participant whose assigned index value is closest to the determined external index value.

### BACKGROUND OF THE INVENTION

The present invention relates to a computerized method and system for awarding a product, service, or activity package to one of a plurality of participants desirous thereof.

The invention relates more particularly to a computerized method and system in which the selected participant is determined on the basis of a value of a given index that is external to, and independent of, the system used to practice the invention.

### BRIEF DESCRIPTION OF THE INVENTION

The method according to the invention is carried out by performing the following basic steps:

a) receiving from a participant a request for a chance to obtain the product, service or package;

b) storing a record of the request and identification of the participant in a database;

c) transmitting to the participant instructions for remitting payment for the chance;

d) receiving confirmation of payment and storing a record of the confirmation in the database;

e) assigning an index value to the share, which may be performed automatically in the system managing the process, or may be selected by the participant, possibly on the basis of a list provided to the participant;

f) transmitting the assigned index value to the participant and storing the assigned index value in the database;

g) repeating steps a) through f) for subsequent participants;

h) determining a value from an external index at a given time;

i) comparing the index value assigned to each participant with the determined external index value; and

j) awarding the product, service, or activity package to that participant whose assigned index value is closest to the determined external index value.

A system for carrying out the invention includes suitable computer apparatus having storage means for storing the database and software for carrying out the method, and a device, particularly a modem, for communication with participants and financial institutions, as well as possibly with the party offering the product, service, or activity package.

Practice of the invention can involve certain procedures disclosed in U.S. Patent Pub. 2002/0010649, filed by Sang-Rae Lee, the disclosure of which is incorporated herein by reference.

### BRIEF DESCRIPTION OF THE DRAWINGS

FIGS. 1, 2 and 3 are programming flow diagrams illustrating one example of a procedure according to the invention.

FIG. 4 is a block diagram of a system for carrying out the invention.

### DETAILED DESCRIPTION OF THE INVENTION

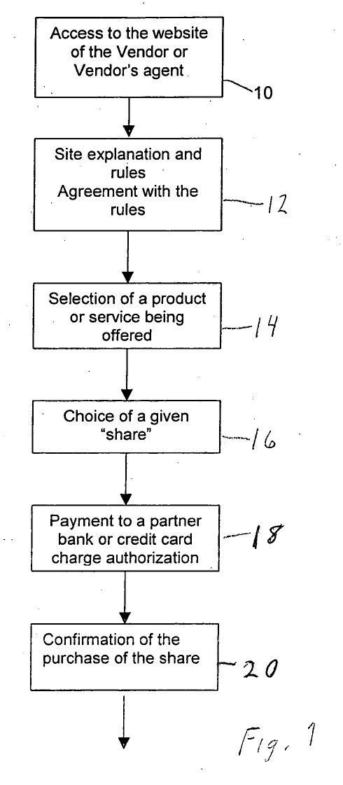

One procedure according to the invention is shown in FIGS. 1-3. FIG. 1 illustrates the manner in which a share is obtained by a participant.

The procedure begins at step 10 when a prospective participant accesses the website of a vendor or an intermediary, on which website products, services, or activity packages are being offered and are displayed and described. If the prospective participant is interested in obtaining one of these, then, in step 12, he can access an explanation of the website and of the rules for becoming a participant. If the prospective participant wishes to proceed, he indicates agreement with the rules and this indication is transmitted to the website. Then, in step 14, the prospective participant is allowed to make a selection of the desired product, service or activity package, and this selection is transmitted to the website. Then, in step 16, the prospective participant indicates a desire to purchase a share and is provided with information for making payment for the share.

In step 18, the participant inputs the data necessary to authorize transfer of payment to the vendor or vendor's agent from a bank or provides authorization for the payment to be charged to a credit card. In step 20, the operator of the website verifies the payment information and issues to the participant confirmation of the purchase of a share and the index value, or number, assigned to that share. As noted earlier herein, the index value may be assigned, possibly at random, by the operator's system, or may be selected by the participant, possibly from a list of available values provided from the website system. The participant also may create his index value. The created index value thus becomes unavailable to the other participants.

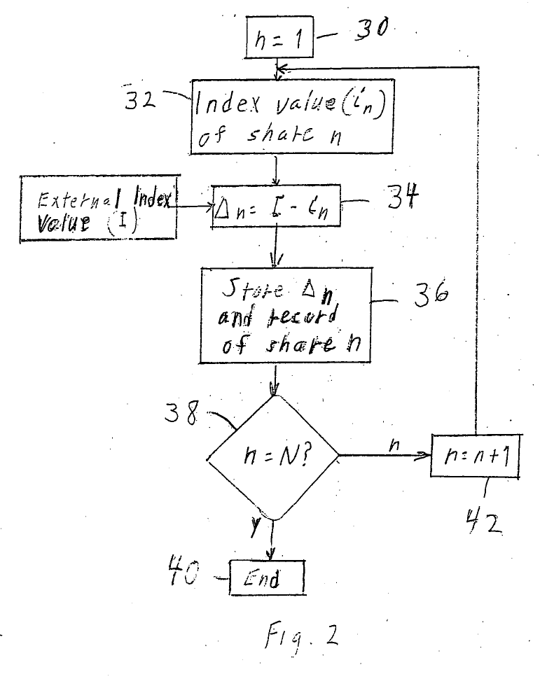

FIG. 2 is a programming flow diagram illustrating a procedure for evaluating the index value associated with each share that has been purchased. Each share that is purchased is given a number, n, starting with 1 for the first share purchased for a given product and increasing by 1 for each succeeding share purchased. Each share identifying number, n, is stored in the database along with an associated unique index value (in), the identity of the participant owning the share and, if necessary, the product with which the share is associated.

In step 30, the procedure is initialized by giving n the value of 1. Then, in step 32, the index value associated with share n is obtained from the database. At the time when the external index value (I) that will be used to determine the winning share has been obtained, this value is subtracted, in step 34, from in, to provide a value, Δn, of the difference therebetween.

In step 36, the determined value for Δn is stored in the database, associated with the other data relating to that share. In decision block 38, a determination is made as to whether n is equal to the number, N, of the last share that was sold. If it is, then the procedure ends at step 40. Otherwise, in step 42, n is incremented by 1 and steps 32-38 are repeated for the new value of n.

Thus, at the end of this process, the difference between each index value iₙ and the external index value, I, is stored in the database.

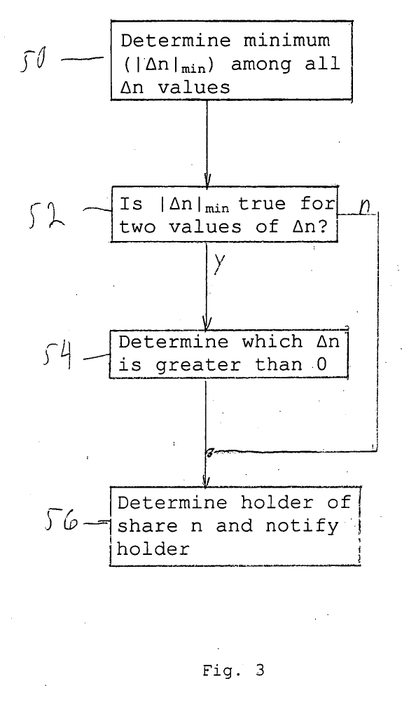

FIG. 3 illustrates a procedure which may then be used to identify the winning participant.

In step 50, all of the stored values for Δn are examined and compared to identify the minimum Δn value. Since each of these values can be positive or negative, depending on whether the associated value iₙ is greater than or less than the value I, the determination is made on the basis of the absolute values for Δn. Since each value Δn may be greater than or less than the value I, it is possible that step 50 will produce two minimum Δn values. It will be recalled that each share is assigned a different in value.

In step 52, a determination is made as to whether there are two minimum values for Δn. If there are two such values, then, in step 54, a determination is made as to which of those two Δn values is positive. This would be based on an arbitrary determination that if there are two Δn values having the same magnitude, the corresponding value of iₙ that is greater than the value of I will be declared the winner.

Then, depending on the result produced in either step 52 or step 54, a determination is made, in step 56, of the winning share and the identity of the holder of that share. The winner will then be notified and arrangements made to provide the item in question to the winner.

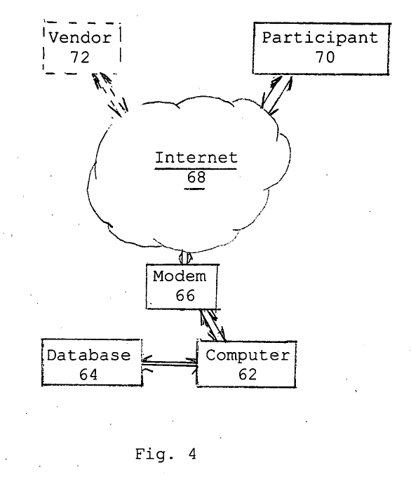

A system for carrying out the invention is illustrated in FIG. 4. This system need only consist of a general purpose computer 62 of suitable capacity, associated with a storage device 64 containing the database and appropriate software. Computer 62 is connected to a modem 66 for communication with the Internet 68. Participants 70 communicate, also via Internet 68, with computer 62.

The system composed of computer 62, database 64 and modem 66 may be operated by the vendor of the various products and services being offered. Alternatively, computer 62, etc., may be operated by a service that represents one or more vendors 72 who are providing the offerings.

The method and system according to the present invention can be employed to offer products, such as, for example, automobiles or electronic products; services of various types, one non-limiting example being tax return preparation services; or activity packages, such as, for example, vacation packages or travel packages.

The external index may be any one of a number of indices whose values cannot be controlled by the operator of the system. Examples of such indices are a Dow Jones index, the NASDAQ index, the S&P index, etc. The external index value employed in the practice of the present invention could be the last three or four digits of the external index occurring at a given time, for example at the close of business, either on a predetermined day or on a day occurring after preferably all of the shares, or a predetermined number of shares, have been sold. Each share sold will have a unique index value, in, thus assuring that at the time the winner is determined, there will not be a tie.

One advantage of the present invention is that it can be implemented with very few participants, possibly less than 100, and even as few as five. The smaller the number of participants, the greater the chance of winning, and in any event far greater than in the case of conventional lotteries, which are invariably structured to have a large number of participants. If for a given contest, the number of shares is reduced, the cost of each share will be relatively high, but the chance of winning is also high. Even if the number of shares is greater, in any case the chance winning remains relatively high, with a relatively low cost of the individual shares. The sum of the share prices must always be greater than the value of that which is received by the winner. For example for a product, service, etc., having a value of $8000, if 100 shares are sold, each share should have a price of at least $100.

Another advantage of the present invention is that there is always a winner.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A computerized method for providing a product, service, or activity package to one of a plurality of participants desiring the product, the service, or package, said method comprising:
a) receiving from a participant a request for a chance to obtain the product, service or package;
b) storing a record of the request and identification of the participant in a database;
c) transmitting to the participant instructions for remitting payment for the chance;
d) receiving confirmation of payment and storing a record of the confirmation in the database;
e) assigning an index value to the share;
f) transmitting the assigned index value to the participant and storing the assigned index value in the database;
g) repeating steps a) through f) for subsequent participants;
h) determining a value from an external index at a given time;
i) comparing the index value assigned to each participant with the determined external index value; and
j) awarding the product, service, or activity package to that participant whose assigned index value is closest to the determined external index value.

2. The method of claim 1, wherein a unique index value is assigned to each share.

3. The method of claim 2, wherein the value from the external index is a selected portion of the index.

4. The method of claim 3, wherein said steps of receiving and transmitting are carried out over the Internet.

5. The method of claim 4, wherein said steps a) through j) are controlled at a host location using a computer and a modem connecting the computer to the Internet.

6. The method of claim 5, wherein the product, service, or package is supplied by a vendor external to the host.
